(19) United States
(12) Patent Application Publication
(10) Pub. No.: US 2004/0084086 A1
(43) Pub. Date: May 6, 2004

(54) INSULATING COVER FOR OUTDOOR FAUCETS

(76) Inventor: Robert S. Stachowiak, Commerce, TX (US)

Correspondence Address: KONNEKER & SMITH P. C., 660 NORTH CENTRAL EXPRESSWAY, SUITE 230, PLANO, TX, 75074, US

(21) Appl. No.: 10/288,026

(22) Filed: Nov. 5, 2002

(51) Int. Cl. F16K 27/08

(52) U.S. Cl. 137/382

(57) ABSTRACT

An insulating cover for outdoor faucets. In a described embodiment, an insulating cover includes inner and outer transparent housings. An insulating air space is formed between the housings. Baffles in the air space substantially prevent air flow through the air space.

### BACKGROUND

The present invention relates generally to plumbing fixtures in structures and, in an embodiment described herein, more particularly provides an insulating cover for outdoor faucets.

Most habitable buildings have at least one external faucet, spigot or hose bib for providing access to a water supply for the building. The term “faucet” is used herein to indicate any external building water supply access fixture or valve.

A typical faucet permits the water therein to extend at least somewhat external to the building, even while the faucet is closed. This presents a problem when the outside temperature falls below the freezing point of water. The water in the faucet could freeze, thereby damaging the faucet and/or any water line connected to the faucet within a wall of the building. When the frozen water melts, it may leak through the damaged faucet and/or water line, causing water damage to the building and wasting the leaked water.

A specially designed “freeze proof” faucet may be used, in which case the water in the faucet does not extend external to the building while the faucet is closed. This solution is often used in new building construction in colder climates. However, retrofitting an existing building by replacing its faucets with “freeze proof” faucets would be a very difficult and expensive undertaking.

Instead, attempts are usually made to protect faucets of existing buildings from freezing. This protection may take the form of insulation wrapped about the faucet, or an insulating cover placed around the faucet. Wrapping insulation about a faucet is difficult and time-consuming. If the insulation becomes wet, it may be ineffective in preventing the water from freezing in the faucet.

Insulating covers are preferred for preventing the water in faucets from freezing. However, typical existing insulating covers are still quite difficult to install and remove. In particular, most insulating covers for faucets require either a complicated sequence of steps to install or remove them from faucets, or they require an attachment to be made to the faucet while the attachment is not visible. Other insulating covers are fragile so that they break easily in normal use (for example, when a faucet attachment is tightened). Still other insulating covers are made of materials which are not suitable for use in an outside environment (for example, they degrade upon exposure to sunlight).

From the foregoing, it can be seen that it would be quite desirable to provide an improved insulating cover for faucets.

### SUMMARY

In carrying out the principles of the present invention, in accordance with an embodiment thereof, an improved insulating cover for faucets is provided. The insulating cover is convenient to install on and remove from a faucet, is made of suitable materials for exterior use, is durable, and is relatively inexpensive to produce.

In one aspect of the invention, an insulating cover for a faucet extending external to a building is provided. The insulating cover includes an inner housing having an open end for receiving the faucet therein and an outer housing having an open end. The inner housing is received in the outer housing open end, thereby forming an insulating air space between the inner and outer housings.

In another aspect of the invention, an insulating cover for a faucet is provided which includes inner and outer spaced apart housings, an attachment member for securing the inner and outer housings to the faucet and a threaded member which is rotated to displace the attachment member relative to the inner and outer housings. The threaded member has spaced apart shoulders thereon which retain the inner and outer housings therebetween.

In yet another aspect of the invention, an insulating cover for a faucet is provided which includes a transparent inner housing received within a transparent outer housing. An insulating air space is formed between the inner and outer housings. External viewing of the faucet is permitted when the faucet is received within the inner and outer housings.

An attachment member secures the inner and outer housings to the faucet. The attachment member is viewable through the inner and outer housings when the attachment member is within the inner and outer housings.

A displacement device displaces the attachment member relative to the inner and outer housings when the attachment member secures the inner and outer housings to the faucet. The displacement device thereby biases the insulating cover into contact with the building.

These and other features, advantages, benefits and objects of the present invention will become apparent to one of ordinary skill in the art upon careful consideration of the detailed description of representative embodiments of the invention hereinbelow and the accompanying drawings.

### BRIEF DESCRIPTION OF THE DRAWINGS

FIG. 1 is a top cross-sectional view of an insulating cover for faucets embodying principles of the present invention;

FIGS. 2A & B are side and end views, respectively, of an outer housing of the insulating cover;

FIGS. 3A & B are side and end views, respectively, of an inner housing of the insulating cover;

FIG. 4 is a side cross-sectional view of the insulating cover operatively installed on a faucet;

FIG. 5 is an alternate side cross-sectional view of the insulating cover operatively installed on a faucet;

FIGS. 6A & B are end cross-sectional views of alternate configurations of the installed insulating cover, taken along line 6-6 of FIG. 5; and

FIGS. 7A & B are end and side views, respectively, of an alternate attachment member for use with the insulating cover.

### DETAILED DESCRIPTION

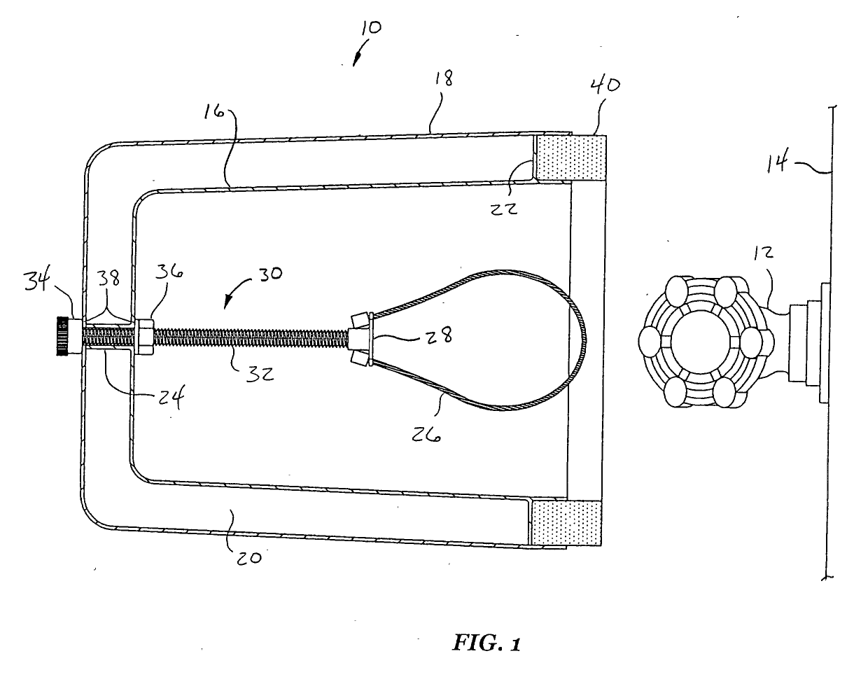

Representatively illustrated in FIG. 1 is a faucet insulating cover 10 which embodies principles of the present invention. In the following description of the insulating cover 10 and other apparatus and methods described herein, directional terms, such as “above”, “below”, “upper”, “lower”, etc., are used only for convenience in referring to the accompanying drawings. Additionally, it is to be understood that the various embodiments of the present invention described herein may be utilized in various orientations, such as inclined, inverted, horizontal, vertical, etc., and in various configurations, without departing from the principles of the present invention.

The insulating cover 10 is used to protect a faucet 12 extending outwardly from a building 14 against freezing. As depicted in FIG. 1, the insulating cover 10 is prepared for installation on the faucet 12. When properly installed on the faucet 12, the insulating cover 10 will enclose the faucet and seat against the building 14.

The insulating cover 10 includes an inner housing 16 and an outer housing 18. The inner housing 16 is received within an open end of the outer housing 18, and is positioned within the outer housing so that an insulating air space 20 is formed between the housings. An outwardly extending flange 22 formed on the inner housing 16 helps to maintain this spaced apart relationship between the open ends of the inner and outer housings 16, 18. An outwardly extending boss 24 formed on the inner housing 16 also helps to maintain this spaced apart relationship between the closed ends of the inner and outer housings 16, 18.

Although the inner and outer housings 16, 18 are described herein as being separately formed, it should be understood that the housings may be formed as one piece by processes such as blow molding or reaction injection molding, without departing from the principles of the present invention.

The insulating cover 10 further includes an attachment member 26, which is used to secure the inner and outer housings 16, 18 to the faucet 12. As depicted in FIG. 1, the attachment member 26 is a flexible wire cable loop configured to encircle a portion of the faucet 12. However, it should be understood that other types of attachment members may be used in place of, or in addition to, the flexible wire loop attachment member 26 illustrated in FIG. 1.

The wire loop 26 is connected to an internally threaded member 28. As depicted in FIG. 1, the internally threaded member 28 is of the type well known to those skilled in the art as a “tee nut” or “weld nut”. However, other types of threaded members may be used without departing from the principles of the invention.

A displacement device 30 is used to reciprocably displace the wire loop 26 relative to the inner and outer housings 16, 18. As depicted in FIG. 1, the displacement device 30 includes an externally threaded member 32 having a knurled head 34 external to the outer housing 18, so that the threaded member may be rotated from the exterior of the insulating cover 10. Other types of heads and other means of rotating the threaded member 32 may be used without departing from the principles of the invention. Furthermore, other types of displacement devices may be used to displace the attachment member 26 in keeping with the principles of the invention.

The threaded member 32 extends through the boss 24. A lock nut 36 on the threaded member 32 is positioned so that the boss 24 is between the head 34 and the lock nut. The head 34 and the lock nut 36 provide outwardly extending shoulders 38, so that the inner and outer housings 16, 18 are retained between the head and the lock nut. However, other means of creating a shoulder, such as a retaining ring or a step on the threaded member 32, may be used in place of the lock nut 36, without departing from the principles of the invention.

It will be readily appreciated that, when the attachment member 26 is engaged with the faucet 12, and as the externally threaded member 32 is rotated (for example, by rotating the head 34 in a clockwise direction), the internally threaded member 28 will advance along the external threads to the left as viewed in FIG. 1. This will displace the wire loop 26 to the left, thereby drawing the wire loop further into the inner and outer housings 16, 18. If the externally threaded member 32 is rotated in an opposite direction, the internally threaded member 28 will advance along the external threads to the right as viewed in FIG. 1. This will displace the wire loop 26 to the right, or toward the open ends of the inner and outer housings 16, 18.

The insulating cover 10 further includes a gasket 40 for sealing against the building 14 when the insulating cover is properly installed on the faucet 12. The gasket 40 is preferably made of an open cell foam to allow it to conform easily to various building exteriors, such as brick and vinyl siding, and in addition, if water should get into the insulating cover 10, the water can drain out through the open cells of the gasket. Thus, the gasket 40 is preferably not a water seal, but instead is used to substantially prevent air transfer between the interior and exterior of the insulating cover 10. However, a material other than open cell foam may be used for the gasket 40 without departing from the principles of the present invention.

The gasket 40 is retained between the inner and outer housings 16, 18. The flange 22 provides anterior support for the gasket 40. Thus, the gasket 40 is supported on three sides by the inner and outer housings 16, 18, which preferably eliminates the need for using an adhesive to attach the gasket to the housings. However, an adhesive or other retaining means may be used to attach the gasket 40 to the housings 16, 18 without departing from the principles of the invention.

The inner and outer housings 16, 18 are preferably made of a transparent material, such as high density polyethylene, polypropylene, PET, etc., which is UV-stabilized for exterior use. The transparency of the housings 16, 18 enables a person installing or removing the insulating cover 10 to view the faucet 12, wire loop 26 and displacement device 30 through the housings. This feature greatly enhances the ease with which the insulating cover 10 may be installed (for example, in encircling a portion of the faucet with the wire loop 26) and removed from the faucet 12 (for example, in disengaging the wire loop from the faucet).

However, it is not necessary for the housings 16, 18 to be transparent in keeping with the principles of the invention. If desired, the housings 16, 18, or either of them, could instead be opaque or translucent. At least the outer housing 18 could be provided in various colors to match or complement the exterior of particular buildings. The inner and/or outer housings 16, 18 could be colored, transparent, translucent or opaque.

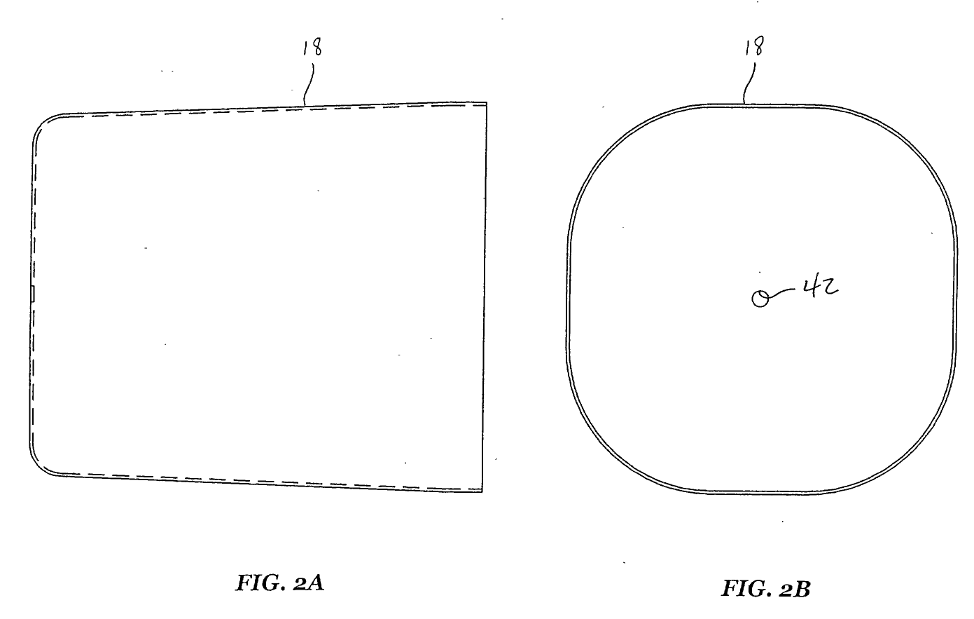

Referring additionally now to FIGS. 2A & B, the outer housing 18 is illustrated apart from the remainder of the insulating cover 10. Note that an opening 42 is provided in the closed end of the outer housing 18 for the threaded member 32 to pass through.

The outer housing 18 has a generally rectangular cross-sectional shape with rounded corners. In addition, the outer housing 18 is tapered somewhat from its open end to its closed end. When the insulating cover 10 is installed on the faucet 12, the external taper of the outer housing 18 provides a slope for water, snow, ice, etc., to drain off of the insulating cover, in a direction away from the building 14. However, the outer housing 18 could have another shape (such as a round cylindrical shape), without departing from the principles of the invention.

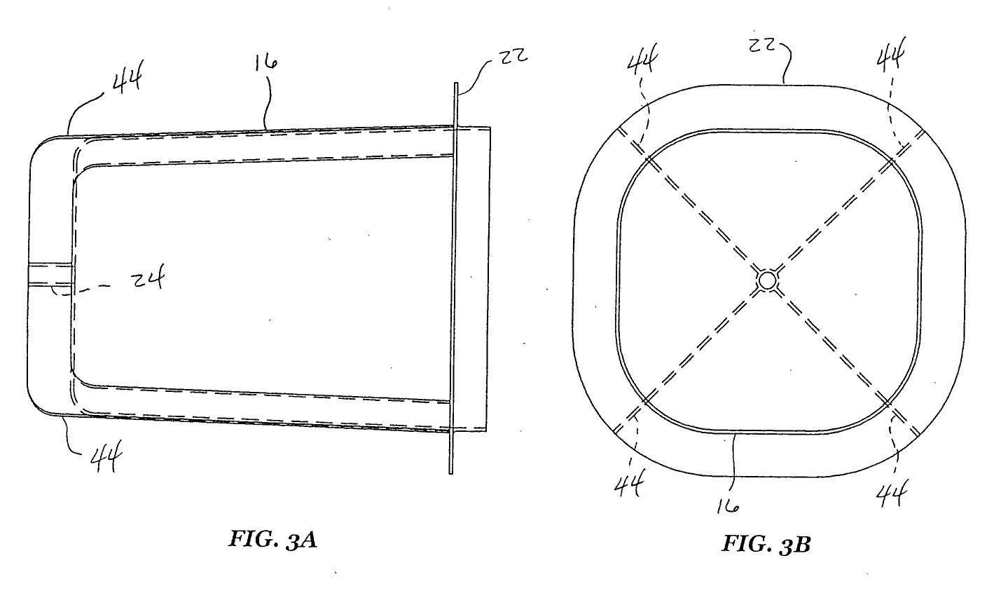

Referring additionally now to FIGS. 3A & B, the inner housing 16 is illustrated apart from the remainder of the insulating cover 10. The inner housing 16 also has a generally rectangular cross-sectional shape with rounded corners, and is tapered somewhat from its open end to its closed end. The inner housing 16 preferably has a shape similar to that of the outer housing 18, so that the exterior of the inner housing is complementarily shaped relative to the interior of the outer housing, but such is not necessary in keeping with the principles of the invention.

Four ribs 44 extend laterally outward from the inner housing 16. Each of the ribs 44 extends from the boss 24 at the closed end of the inner housing 16 to the flange 22 at the open end of the inner housing. The ribs 44 are preferably positioned at the corners of the inner housing 16. However, it should be understood that any number of the ribs 44, and any positioning of the ribs, may be used without departing from the principles of the invention.

The ribs 44 provide structural support and help to maintain the spaced apart relationship between the inner and outer housings 16, 18. In addition, the ribs 44 serve as baffles to prevent air movement between portions of the air space 20 separated by the ribs. This aids in preventing heat loss due to convection from the insulating cover 10, as described more fully below.

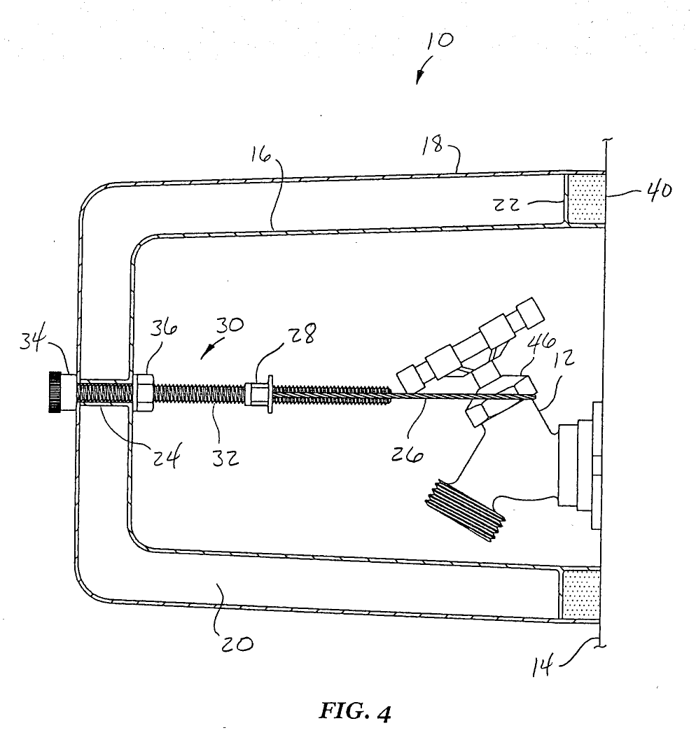

Referring additionally now to FIG. 4, the insulating cover 10 is representatively illustrated operatively installed on the faucet 12. To accomplish the installation, the wire loop 26 is placed over a portion of the faucet 12, such as a packing bonnet 46, and the externally threaded member 32 is rotated (for example, by rotating the head 34 clockwise) to displace the internally threaded member 28 to the left. Since the inner and outer housings 16, 18 are transparent, a person performing the installation can easily see and manipulate the various components of the insulating cover 10 from the exterior thereof.

Continued rotation of the threaded member 32 will tighten the wire loop 26 between the displacement device 30 and the faucet 12, causing the insulating cover 10 to be biased into contact with the building 14. As depicted in FIG. 4, the gasket 40 has been compressed between the flange 22 and the building 14, and the inner and outer housings 16, 18 are in contact with the building.

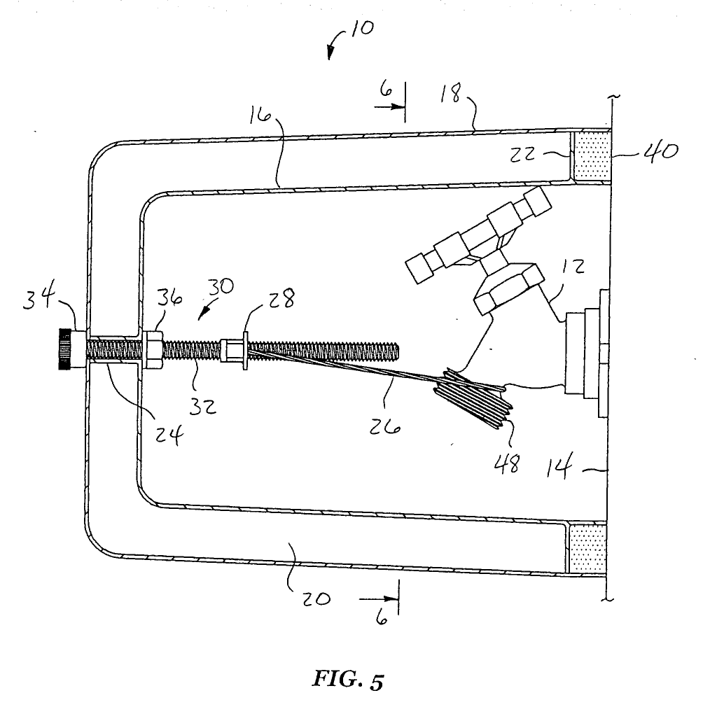

Referring additionally now to FIG. 5, the insulating cover 10 is again illustrated as operatively installed on the faucet 12. However, in this view it may be seen that the wire loop 26 is engaged with another portion of the faucet 12, above an externally threaded hose attachment 48. This view demonstrates that the insulating cover 10 may be installed using a variety of methods, without departing from the principles of the invention.

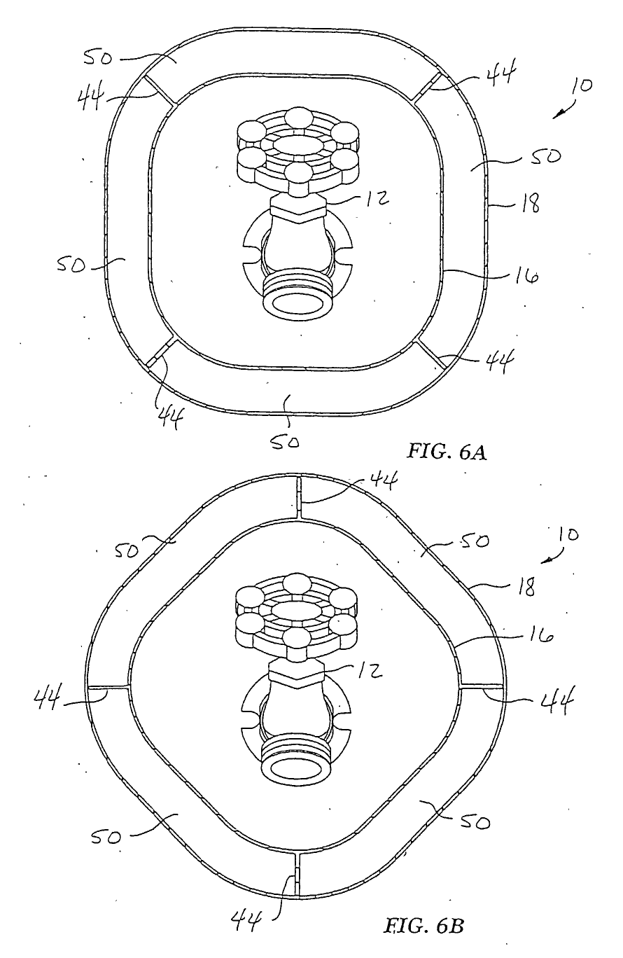

Referring additionally now to FIGS. 6A & B, the insulating cover 10 is shown in cross-section and with the faucet 12 received therein. In FIG. 6A, the inner and outer housings 16, 18 are oriented so that a substantially flat side of each housing is facing upward. In FIG. 6B, the inner and outer housings 16, 18 are oriented so that a rounded corner of each is facing upward.

The FIG. 6A orientation may blend better aesthetically with the lines of the building 14, enable the gasket 40 to seal more effectively against siding on the building, etc. The FIG. 6B orientation may provide better support against loads on the insulating cover 10, such as loads due to snow or ice accumulation on the top of the insulating cover. The rounded corner on the top of the insulating cover in the FIG. 6B orientation may also help to prevent accumulation of snow and ice on the insulating cover.

In FIGS. 6A & B, it may also be more clearly seen how the ribs 44 form baffles between portions 50 of the air space 20 separated by the ribs. The ribs 44 substantially, or completely, prevent air flow between the air space portions 50, which reduces heat loss due to convection between the inner and outer housings 16, 18.

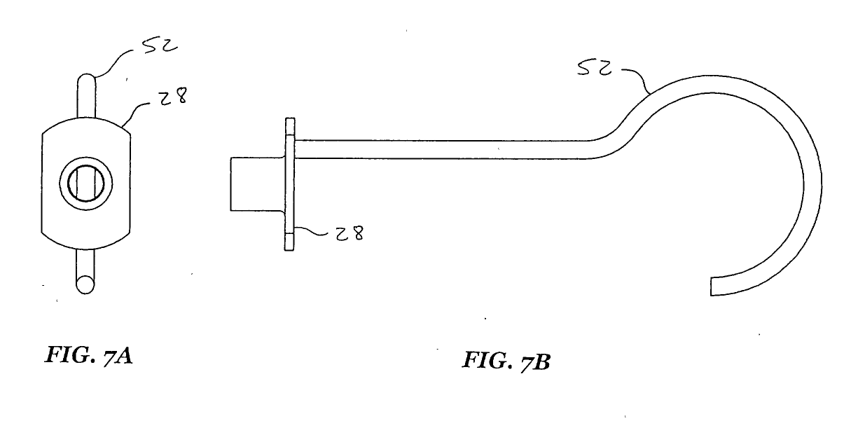

Referring additionally now to FIGS. 7A & B, an alternate attachment member 52 is representatively illustrated. The attachment member 52 is in the form of a rigid formed wire hook. This hook 52 may be used in place of the wire loop 26 described above.

The hook 52 may attach to the faucet 12 in much the same manner as the wire loop 26, except that it does not encircle a portion of the faucet as completely as the wire loop. Thus, the hook 52 may attach to the faucet 12 below the bonnet 46 (as depicted for the wire loop 26 in FIG. 4), above the hose attachment 48 (as depicted for the wire loop in FIG. 5), or at another position on the faucet.

As depicted in FIGS. 7A & B, the hook 52 is attached to the internally threaded member 28, for example, by welding, soldering or brazing.

Alternatively, the hook 52 could be provided with internal threads integrally formed thereon.

Thus, FIGS. 7A & B demonstrate that a variety of attachment members may be used in the insulating cover 10, without departing from the principles of the invention.

Of course, a person skilled in the art would, upon a careful consideration of the above description of representative embodiments of the invention, readily appreciate that many modifications, additions, substitutions, deletions, and other changes may be made to these specific embodiments, and such changes are contemplated by the principles of the present invention. Accordingly, the foregoing detailed description is to be clearly understood as being given by way of illustration and example only, the spirit and scope of the present invention being limited solely by the appended claims and their equivalents.

What is claimed is:

1. An insulating cover for a faucet extending external to a building, the insulating cover comprising:
an inner housing having an open end for receiving the faucet therein; and
an outer housing having an open end, the inner housing being received within the outer housing, thereby forming an insulating air space between the inner and outer housings.

2. The insulating cover according to claim 1, wherein the air space is enclosed, substantially preventing air flow between the air space and an exterior of the insulating cover.

3. The insulating cover according to claim 1, further comprising at least one air baffle positioned in the air space, the air baffle restricting air flow in the air space.

4. The insulating cover according to claim 3, wherein the baffle is externally formed on the inner housing, the air baffle extending outwardly into the air space.

5. The insulating cover according to claim 3, wherein there are multiple air baffles, the air baffles dividing the air space into multiple substantially isolated portions.

6. The insulating cover according to claim 1, wherein each of the inner and outer housings is transparent.

7. The insulating cover according to claim 1, further comprising a gasket retained between the open ends of the inner and outer housings, the gasket being configured for contacting the building when the faucet is operatively received within the insulating cover.

8. The insulating cover according to claim 1, further comprising a flexible loop reciprocably disposed relative to the inner and outer housings, the loop being configured for securing the inner and outer housings to the faucet.

9. The insulating cover according to claim 1, wherein the inner and outer housings are formed as a single piece.

10. An insulating cover for a faucet extending external to a building, the insulating cover comprising:
inner and outer spaced apart housings;
an attachment member for securing the inner and outer housings to the faucet; and
a threaded member which is rotated to displace the attachment member relative to the inner and outer housings, the threaded member having spaced apart shoulders thereon which retain the inner and outer housings therebetween.

11. The insulating cover according to claim 10, wherein the spaced apart shoulders on the threaded member comprise a head of the threaded member and a nut threaded onto the threaded member.

12. The insulating cover according to claim 10, further comprising a boss formed on one of the inner and outer housings, the boss maintaining a predetermined separation distance between the inner and outer housings, and the threaded member extending through the boss.

13. The insulating cover according to claim 10, further comprising at least one elongated rib extending laterally between the inner and outer housings, the rib maintaining a predetermined separation distance between the inner and outer housings.

14. The insulating cover according to claim 13, wherein the rib forms an air baffle substantially preventing air flow between the inner and outer housings.

15. The insulating cover according to claim 10, wherein each of the inner and outer housings is transparent.

16. The insulating cover according to claim 10, further comprising a gasket configured for contacting the building when the faucet is operatively received within the insulating cover, the gasket being retained between the inner and outer housings.

17. The insulating cover according to claim 10, wherein the inner and outer housings are formed as a single piece.

18. An insulating cover for a faucet extending external to a building, the insulating cover comprising:
a transparent inner housing received within a transparent outer housing, thereby forming an insulating air space between the inner and outer housings, and thereby permitting external viewing of the faucet when the faucet is received within the inner and outer housings;
an attachment member for securing the inner and outer housings to the faucet, the attachment member being viewable through the inner and outer housings when the attachment member is within the inner and outer housings; and
a displacement device for displacing the attachment member relative to the inner and outer housings when the attachment member secures the inner and outer housings to the faucet, the displacement device thereby biasing the insulating cover into contact with the building.

19. The insulating cover according to claim 18, wherein the attachment member comprises a flexible loop connected to an internally threaded member.

20. The insulating cover according to claim 19, wherein the displacement device comprises an externally threaded member extending at least partially external to the inner and outer housings.

21. The insulating cover according to claim 20, wherein the inner and outer housings are retained between spaced apart shoulders on the displacement device.

22. The insulating cover according to claim 18, further comprising multiple air baffles positioned in the insulating air space, the air baffles substantially preventing air flow between portions of the air space isolated by the baffles.

23. The insulating cover according to claim 18, wherein the inner and outer housings are formed as a single piece.
